(19) United States
(12) Patent Application Publication
(10) Pub. No.: US 2009/0186205 A1
(43) Pub. Date: Jul. 23, 2009

(54) MATERIAL IN SHEET FORM HAVING A WINDOW, ITS MANUFACTURING METHOD AND SECURITY DOCUMENT COMPRISING IT

(75) Inventors: Pierre Doublet, Saint Brice (FR); Michel Camus, Rives Sur Fure (FR)

Correspondence Address: OLIFF & BERRIDGE, PLC, P.O. BOX 320850, ALEXANDRIA, VA, 22320-4850, US

(73) Assignee: ARJOWIGGINS SECURITY, ISSY LES MOULINEAUX (FR)

(21) Appl. No.: 12/303,043

(22) PCT Filed: Jun. 5, 2007
(86) PCT No.: PCT/FR07/51376

§ 371 Date: Mar. 11, 2009

(30) Foreign Application Priority Data
Jun. 6, 2006 (FR) 0604975

(51) Int. Cl. B32B 7/00; B31F 1/07

(52) U.S. Cl. 428/215; 162/132; 162/109

(57) ABSTRACT

The present invention relates to a material in sheet form comprising at least two fibrous jets juxtaposed on each other, a first jet comprising at least one long area of zero thickness and a second jet comprising at least one aperture, and said at least one aperture of the second jet being located facing the said at least one long area of zero thickness of the first jet, thus forming a window.

The present invention relates to a material in sheet form comprising at least one window, to its method of manufacture, and to a security document comprising said material.

Already known in the prior art are various security sheets provided with windows that may or may not penetrate the entire thickness so that, in particular, a security element positioned in the region of the window can be seen. In general, these windows are openings made in the security sheet and covered by a partially transparent security element such as a foil or patch that may contain a security element.

Patent GB 1 552 853 discloses a banknote comprising a layer of paper within which a security thread is incorporated. The layer of paper has opposing windows allowing the security thread to be seen. The windows may be created using a laser capable of removing material from the layer of paper while at the same time leaving the security thread intact. The windows may, as an alternative, be created mechanically, by cutting or abrading.

Patent application EP 229 645 discloses a security paper comprising two plies of paper between which a security thread is interposed. Holes are made in at least one of the plies of paper using reliefs on the wire cloth used to form this ply of paper.

Patent application EP 0 687 324 also discloses a method of manufacturing a two-ply sheet of paper comprising at least one region the thickness of which is reduced by comparison with the thickness of the remainder of the sheet. This then yields a practically transparent zone without the need to pierce the paper in this zone.

Application WO 95/09274 also discloses a sheet of security paper made up of two layers each having a zone of zero thickness facing one another and a strip of transparent material enrobed in the sheet of paper so that the strip of transparent material faces the zones of zero thickness. This then yields a transparent window.

However, the sheets thus obtained have the disadvantage of having, on their faces, differences in thickness, particularly in the form of additional thickness in the region of the inserted strip, which means that if the surface area of the zones of reduced or zero thickness is large, the sheet becomes industrially awkward to handle. This is because in order to be able to store or to transport the sheets, they are stacked in large numbers, which means that the zones of reduced thickness become superposed with one another, causing the stack to be unstable.

Application WO 2004/001130 describes a method of creating a paper substrate that consists in bringing a security thread into contact with a papermaking wire cloth, the wire cloth having reliefs the purpose of which is to create on the substrate windows through which one edge of the security thread is visible. This method is unsuited to the incorporation into the paper substrate of a security thread of relatively substantial width because when a wide thread is incorporated, visible defects such as an absence of material may appear on the surface of the layer of paper.

Also disclosed, in Patent Applications EP 0 860 298 and EP 0 625 431, is a method of manufacturing a security paper in which a security thread is incorporated within a first layer of paper using the so-called “window thread” technique described in Patent Application EP 0 059 056. This layer of paper has, on one face, a plurality of windows revealing the security thread. If the security thread is relatively wide, in particular is more than 2 mm wide, the first layer is then assembled with a second layer of paper in order to conceal the defect or defects.

Also known, from patent U.S. Pat. No. 6,428,051, is a security paper comprising a fibrous layer that has a window covered by a foil, the window being created by stamping the fibrous layer. The dimensions and/or the shape of the window depend on the stamping tool used, which means that the tool has to be changed if windows of different dimensions and/or shapes are to be formed.

It is a first object of the present invention to provide a new security sheet with a window comprising a security element, preferably a fairly large one, and which in particular does not have any appreciable increase in thickness.

It is another object of the present invention to provide a new material in sheet form that can be used to create such a security sheet.

Thus, a subject of the invention is a material in sheet form comprising at least two fibrous plies juxtaposed on one another, such that the first ply comprises at least one elongate zone of zero thickness and such that the second ply comprises at least one recess, and said at least one recess of the second ply is situated facing the at least one elongate zone of zero thickness of the first ply and forms a window.

This then yields a material in sheet form of which the structure comprises, in the region of superposition of the elongate zone of the first ply with the recess of the second ply, a transparent window.

Each elongate zone of zero thickness of the first ply has a width preferably of between 5 and 50 mm, and more preferably of between 10 and 25 mm.

As a preference, said at least one elongate zone of zero thickness extends along the entire length of said first ply.

According to one preferred embodiment, the first ply comprises several elongate zones of zero thickness, parallel to one another, over the entire surface of the said ply so that said first ply has the appearance of a succession of parallel spaced-apart fibrous strips.

According to another embodiment of the invention, the first ply further comprises at least one at least partial absence of material situated in at least one fibrous region. In this way, a structured first ply is obtained that is particularly difficult to forge. In addition, a structure such as this makes it possible, by virtue of the absences of material, to obtain tactile effects that allow the material to be recognized by touch.

According to one embodiment, the absences of material are partial, that is to say that, in the region of said absences, the thickness of the first ply is reduced. If appropriate, if the thickness of the first ply is reduced enough in the absences of material, said absences will allow the second ply to be seen through them by transparency.

According to another embodiment, the absences of material are complete absences, that is to say that, at said absences, the thickness of the first ply is zero. In this special case, the absences of material allow the second ply to be seen directly.

According to one embodiment, the absences may extend over the entire width of the fibrous region in which they are situated.

In another embodiment, the absences of material do not extend over the entire width of the fibrous region in which they are situated.

The absences may be of different shapes, for example may have geometric shapes such as circular, triangular, square, rectangular or similar shapes.

As a preference, and in order to ensure that the structure of the material in sheet form is robust and very cohesive, said at least one recess of the second ply has a width less than or equal to the width of the at least one elongate zone of zero thickness of the first ply. As a preference, the width of each recess of the second ply is at least 5 mm less than the width of the corresponding elongate zone of zero thickness of the first ply.

What happens is that because the first ply has an elongate zone entirely devoid of fibrous material, the region surrounding this zone of zero thickness is weaker than the region facing it belonging to the second ply which contains only discrete recesses devoid of fibrous material. This is why preference is given to a support the structure of which is such that the edges of the first ply on each side of said elongate zone of zero thickness rest on the second ply.

Depending on the envisioned ulterior use of the material in sheet form according to the invention, its total thickness may vary between 70 μm and 2 mm, and preferably between 90 and 300 μm.

According to one embodiment of the invention, the first and second plies are of equal thicknesses. According to another embodiment of the invention, the first and second plies of different thicknesses. In particular, the second ply comprising the recesses has a thickness in excess of 60 μm in order to avoid weakening said second ply as a result of the presence of the recesses, it being necessary for said ply to be relatively robust so that it can support the first ply during the manufacture of the material in sheet form. The first ply, being made up of continuous strips of paper, can for its own part be less thick. For example, the material in sheet form has a total thickness of 110 μm, the first ply being 25 μm thick and the second ply being 85 μm thick,

According to one embodiment of the invention and in order to increase its level of security, the first and/or second ply of material in sheet form comprises at least one security element. Advantageously, the security elements are positioned in the thicker ply, preferably the second ply. For example, the first and/or the second ply contains a watermark or a security thread.

In the embodiment in which the fibrous regions of the first ply have absences of material, it is particularly advantageous for the second ply to comprise security elements situated facing these absences of material.

One of the advantages of the invention is that, according to one particular embodiment, one of the plies may contain a wide security thread, that is to say a security thread more than 2 mm wide, particularly between 2 and 10 mm wide, preferably about 3 mm wide, the zone into which this thread is incorporated being covered by the other ply which thus conceals the defects that this thread has created.

The recesses in the second ply may have different geometric shapes, and for example may be circular, rectangular, square, egg-shaped, triangular, hexagonal or the like. Alternatively, it is possible to envision recesses having the shape of alphanumeric characters, or symbols.

In one particular embodiment, the second ply comprises several recesses arranged in such a way as to form a code.

The invention also relates to a security sheet comprising said material in sheet form and a security element in the window of said material in sheet form.

More specifically, according to the invention, the material in sheet form also comprises an at least partially transparent element situated at least partially in the at least one elongate zone of zero thickness of the first ply and facing at least one recess of the second ply.

This element may for example be a patch, or preferably a continuous strip.

What is meant here by “patch” is a flat element of small dimensions, that is to say of dimensions very much smaller than those of the backing on which it is affixed, particularly a square, round or oval shape. For example, said at least partially transparent element may be in the form of a patch in the shape of a square with sides 1.5 cm long.

According to one embodiment of the invention, the at least partially transparent element has a thickness of between 10 and 50 μm. Advantageously, this element has the same thickness as the elongate zone which means that the exterior surface of the first ply is flat and exhibits no increase in thickness. For example, the first ply of the sheet is 20 μm thick, and a continuous strip of the same thickness is inserted in the zone of zero thickness of the first ply.

According to one particularly advantageous embodiment, the at least partially transparent element is a continuous strip the dimensions of which correspond to those of the elongate zone of zero thickness of the first ply so that said elongate zone of zero thickness is entirely compensated for by said continuous strip. This advantageously yields a security sheet of which the face corresponding to the first ply is flat.

By comparison with single-ply security sheets of the prior art, the security sheet according to the invention has the advantage that, being made up of a number of plies, the thickness of the first ply can be adapted to suit the thickness of the transparent element thus making it possible to obtain a flat sheet, irrespective of the choice of thickness of the transparent element.

According to one embodiment of the invention, the backing for the at least partially transparent element is a synthetic material, for example a polyester film.

According to one particularly advantageous embodiment of the invention, the at least partially transparent element comprises at least one security means. In particular, said at least partially transparent element comprises a variable optical effect device, an interferential, particularly iridescent and/or diffractive device, a liquid crystal device, a system of lenses, a hologram, a magnetic, metallic or crystalline coating, magnetic fibers, tracers that can be detected by magnetic resonance, tracers that can be detected by x-ray fluorescence, biomarkers, a lacquer or ink, luminescent, particularly fluorescent tracers, or photochromic, thermochromic, electroluminescent and/or piezochromic and/or tribometric compounds and/or compounds which change color upon contact with one or more predetermined products, or any other similar security means.

In another example, the at least partially transparent element comprises at least one security means, and the total thickness of the at least partially transparent element is similar to the thickness of the material in sheet form, said security means being positioned facing a recess of the second ply. For example, a security means 40 μm thick may be positioned in the at least partially transparent element.

One advantage of the security sheet according to the invention is that its structure allows it to contain devices which are thicker than the foils generally used in transparent windows, that is to say chips or tactile devices. Specifically, the foils usually employed are of the order of 5 to 10 μm thick, whereas chips or tactile devices may be 30 to 90 μm thick.

According to one particular embodiment of the invention, the security sheet is such that the second ply of material in sheet form comprises at least one watermark with a multitonal effect situated facing the at least partially transparent element of an elongate zone of zero thickness of the first ply. A multitonal watermark such as this is made up of pale zones, that is to say of zones the thickness of which is less than the thickness of the remainder of the sheet, arranged in such a way as to form a ribbed pattern. Ribbed watermarks such as this are described in Patent Application EP 1122360.

This embodiment is particularly advantageous because it improves the durability of a watermark of multitonal effect. Specifically, watermarks with a multitonal effect are security elements that are very difficult to reproduce. However, creating them entails locally reducing the thickness of the sheet of paper very substantially, making them sensitive to wear and leading to the risk that the sheet of paper will become holed. This risk is all the greater when the documents comprising security sheets, such as banknotes, have to be handled very frequently. By positioning the watermark with multitonal effect facing an at least partially transparent element of an elongate zone of zero thickness of said first ply, said watermark of multitonal effect is protected and the risk of holes becoming formed is prevented.

According to one particular embodiment, at least one security means of the at least partially transparent element is situated precisely facing a recess of the second ply. This then yields a security sheet comprising at least one security means that can be seen at a window. It is likewise envisioned that the at least partially transparent element will comprise several security means just some of which are situated facing recesses in the second ply, and others of which are not.

The invention also relates to a security document comprising the above-described security sheet. For example, the invention relates to a means of payment such as a banknote or check, to an identity document such as an identity card, a driver's license, a page of a passport or a visa, or some other official document such as a title document or a diploma, or any other paper-based document requiring security measures, or alternatively security packaging or a label.

According to one particular embodiment of the invention, the security document comprising said sheet is such that said first ply comprises at least two security elements facing at least two security recesses of the second ply, said two security elements being positioned in such a way that they become superposed when the security document is folded, in order to form an additional security feature or additional information. For example, a first security element may be an array of lenses which will cover a second security element consisting of an invisible image that will not be revealed until the two security elements are superposed. In another example, a first security element will be a polarized filter and a second security element will be liquid crystals which, for example, form an image revealed by the filter.

The invention also relates to a method of manufacturing the material in sheet form.

According to the invention, this method of manufacture involves the following steps:
creating a first ply of paper comprising at least one elongate zone of zero thickness by filtering an aqueous suspension of cellulose fibers on the wire cloth of a first cylinder mold or of a former,
creating a second ply of paper on the wire cloth of a second cylinder mold in such a way as to form at least one recess in said second ply,
assembling the two plies in such a way that at least one recess of the second ply faces said at least one elongate zone of zero thickness of the first ply, thus forming a window,
drying the structure thus obtained.

According to one specific scenario of the invention, said elongate zone of zero thickness of the first ply is created by omitting to filter the suspension over at least one zone of the wire cloth of said first cylinder mold or of said former. According to one particular scenario of the invention, the omission of filtration on the first cylinder mold or on the former is achieved by depositing masking zones on the perimeter of said first cylinder mold or of said former. For example, these masking zones are created using masks made of an adhesive film, made of metal, made of an adhesive or alternatively made of a lacquer.

According to another specific scenario of the invention, the wire cloth of said first cylinder mold or of the former is additionally equipped with components that prevent the filtration of the suspension so as to form complete absences in the fibrous material of the first ply. According to yet another specific scenario of the invention, the wire cloth of said first cylinder mold or former has embossings so as to form partial absences in the fibrous material of the first ply. In these two specific scenarios, this then yields a material in sheet form that has a structured first ply that is particularly difficult to reproduce.

According to another embodiment of the invention, said elongate zone of zero thickness of the first ply is created by the removal of material by spraying a jet of pressurized fluid, particularly a jet of water or air, onto the first ply while it is still wet before it is assembled with the second ply.

According to one embodiment, the at least one recess in the second ply is created by a raised embossing of the wire cloth of the second cylinder mold, thus preventing fibrous material from being deposited in the regions of the embossings.

It is also conceivable to obtain the recesses by attaching to the wire cloth of the second cylinder mold components that prevent filtration, for example a piece of metal, particularly an electrotype (that is to say a metal sheet, generally made of bronze), a piece of adhesive, or a piece of resin. The shape of the piece will then dictate the shape of the recess. It is envisioned that use be made of pieces of different shapes in order to create recesses of different shapes.

Finally, the recesses may be created by the removal of material using the spraying of a jet of pressurized fluid, particularly a jet of water, onto the second ply while it is still wet, before it is assembled with the first ply.

The invention relates finally to a method of manufacturing a security sheet involving the manufacture of a material in sheet form according to one of the embodiments described hereinabove and additionally comprising a step which consists in attaching an at least partially transparent element into the elongate zone of zero thickness of the first ply of the material in sheet form.

According to one particular embodiment, the at least partially transparent element is at least attached to the second ply, for example using a hot melt adhesive, in the elongate zone of zero thickness of the first ply. Attachment may be achieved by transferring a foil or a patch into said elongate zone of zero thickness or alternatively by adhesive coating and applying the at least partially transparent element.

The invention will now be described in greater detail with the aid of the attached drawing in which:

FIG. 1 depicts a transverse view of a material in sheet form according to one embodiment of the invention;

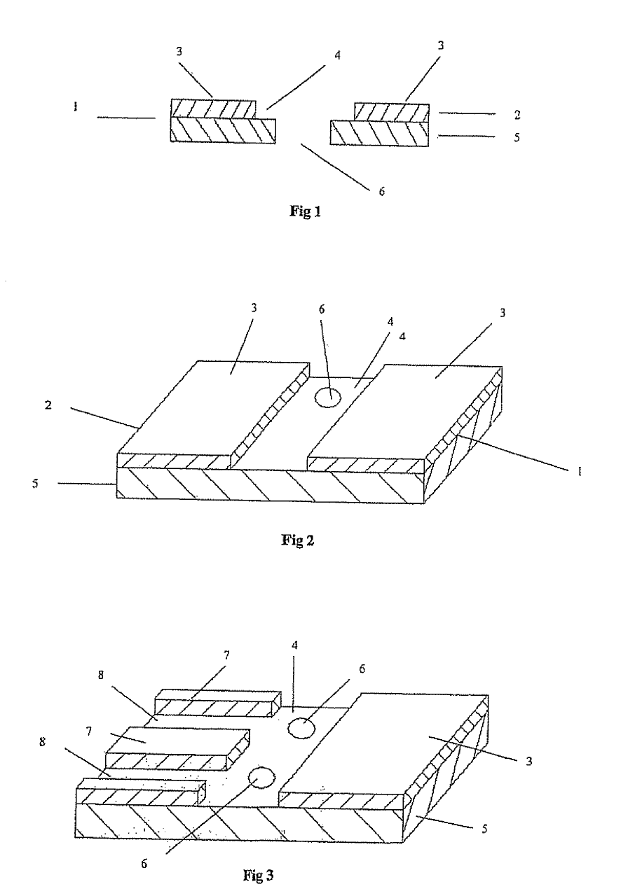

FIG. 2 depicts a plan view of the material in sheet form of FIG. 1;

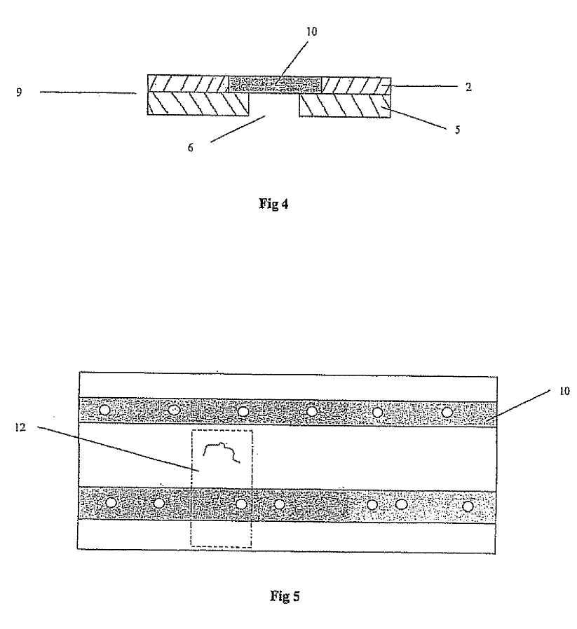

FIG. 3 depicts a plan view of a material in sheet form according to another embodiment of the invention;

FIG. 4 depicts a transverse view of a security sheet according to the invention, in the region of the window;

FIG. 5 depicts a plan view of a security sheet used to manufacture a security document according to the invention;

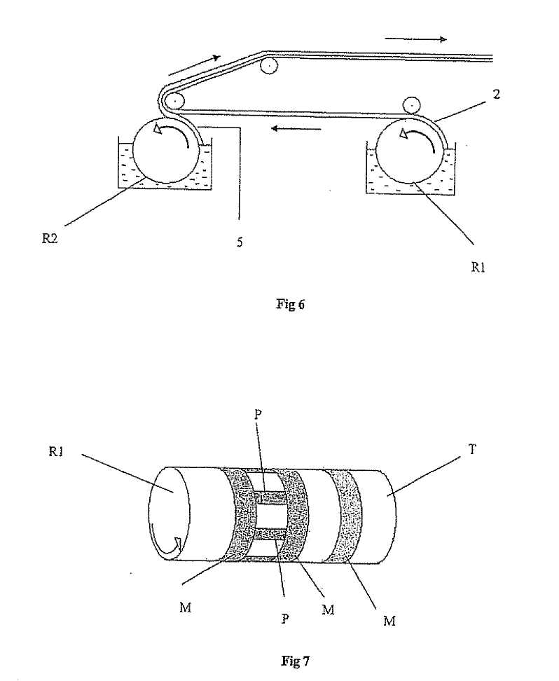

FIG. 6 is a diagram illustrating the various stages in the manufacture of a material in sheet form according to the invention; and

FIG. 7 is a diagram illustrating one of the cylinder molds used for manufacturing a material in sheet form according to one embodiment of the invention.

For the purposes of clarity, the various components are not drawn strictly to scale and, in FIGS. 1 to 4 that follow, just one elongate zone of zero thickness has been depicted in the first ply of the material in sheet form, this being surrounded by two zones of fibrous material.

FIG. 1 and FIG. 2 illustrate one embodiment in which the material in sheet form (1) is made up of two plies of fibrous material. The first ply of fibrous material (2) exhibits an alternation of elongate zones of fibrous material (3) and elongate zones of zero thickness (4). The second ply of fibrous material (5) exhibits a number of circular recesses (6) situated facing an elongate zone of zero thickness (4) of the first ply (2).

In particular, in the scenario illustrated in FIGS. 1 and 2, the first and second plies have different thicknesses, the first ply (2) being 40 μm thick and the second ply being 70 μm thick. The second ply of fibrous material (5) has several circular recesses (6) situated facing an elongate zone of zero thickness (4) of the first ply (2).

FIG. 3 illustrates an embodiment in which the material in sheet form (1) likewise consists of a first ply (2) and of a second ply (5) of fibrous material. The first ply of fibrous material (2) comprises elongate zones of zero thickness (4), zones of fibrous material (7) with rectangular-shaped absences (8) of material extending over the entire width of said zones of fibrous material, and fibrous regions (3) with no absences of material. Just as in the embodiment illustrated in FIGS. 1 and 2, the second ply (5) exhibits several circular recesses (6) situated facing an elongate zone of zero thickness (4) of the first ply.

FIG. 4 illustrates a security sheet (9) according to the invention, comprising a material in sheet form as depicted in FIGS. 1 and 2, and a transparent polyester film (10) inserted in the elongate zone of zero thickness (4) of the first ply (2) facing the circular recesses (6) of the second ply (5). The transparent film (10) has the same width and the same thickness as the elongate zone of zero thickness (4) into which it is inserted, which means that there is no additional thickness in the region of this film (10) and that the face of the sheet is flat.

FIG. 5 illustrates a sheet of paper for a banknote (11) according to the invention, which comprises the security sheet (9) depicted in FIG. 4 and a watermark (12) created in the second ply (5).

FIG. 6 is a diagram illustrating the various stages in the manufacture of a material in sheet form such as the materials in sheet form shown in FIGS. 1 to 3.

The first ply (2), which has elongate zones of zero thickness (4), is made from an aqueous suspension of cellulose fibers, using a first cylinder mold (R1) on the wire cloth of which masks (M) are attached. In this way, the fibrous suspension is deposited only in the regions devoid of masks (M). This then yields a first wet ply (2) made up of an alternation of elongate zones of zero thickness (4) and of zones of fibrous material.

The first ply (2) thus formed is carried toward a second cylinder mold (R2) so that it can be deposited onto the second fibrous ply (5) that is in the process of being formed. The second ply (5) is formed on the wire cloth of the second cylinder mold, to which there have been attached elements that prevent the suspension from being filtered. The elements are positioned at identified positions such that they will form recesses (6) in register with the positions of the elongate zones of zero thickness (4) of the first ply (2). This then yields a second wet ply (5) made up of fibrous material with recesses (6).

At the exit from the second mold, the first ply (2) is deposited onto the second ply (5). This yields a two-ply sheet which can then have a surface treatment or be impregnated, for example may have its surface reinforced with PVA and/or receive a treatment improving its resistance to soiling or alternatively improving its printability, particularly using a coating press or an impregnator. This sheet is then dried and reeled according to customary practice.

FIG. 7 is a diagram illustrating the first cylinder mold (R1) used in the manufacture of a material in sheet form (1) according to the invention, in the specific scenario in which the first fibrous ply (2) of said material in sheet form (1) comprises elongate zones of zero thickness (4) and fibrous regions that have complete absences of material (8).

The wire cloth (T) of the first cylinder mold (R1) has rectangular masks made of an adhesive film (M) arranged on it in such a way as to extend, at uniform intervals, over the entire perimeter of the cylinder mold (R1) Thus, in the region of said masks (M), the suspension of fibers will not be deposited and the first fibrous ply (2) will exhibit zones of zero thickness (4). In the example illustrated, the first cylinder mold (R1) further comprises rectangular pieces of metal (P) positioned on the wire cloth (T) between two adjacent masks (M). These pieces (P) prevent the filtration of the suspension of fibers, and therefore prevent any fibrous deposit, which means that the fibrous regions (3) of the first ply (2) will exhibit complete absences of material (7).

1. A material in sheet form comprising at least two fibrous plies juxtaposed on one another, a first ply comprising at least one elongate zone of zero thickness and a second ply comprising at least one recess, and said at least one recess of the second ply being situated facing said at least one elongate zone of zero thickness of the first ply, thus forming a window.

2. The material in sheet form as claimed in claim 1, wherein at least one elongate zone of zero thickness of the first ply extends over the entire length of said first ply.

3. The material in sheet form as claimed in claim 1, wherein said first ply further comprises at least one at least partial absence of material in at least one region of non-zero thickness.

4. The material in sheet form as claimed in claim 3, wherein said at least one absence extends over the entire width of the region of non-zero thickness comprising it.

5. The material in sheet form as claimed in claim 1, wherein said one recess of the second ply has a width less than or equal to said elongate zone of zero thickness of said first ply facing said recess.

6. The material in sheet form as claimed in claim 5, wherein the width of said recess of the second ply is at least 5 mm smaller than the width of said elongate zone of zero thickness of the first ply positioned facing said recess.

7. The material in sheet form as claimed in claim 1, wherein the width of said zone of zero thickness of the first ply is between 5 and 50 mm.

8-42. (canceled)

43. The material in sheet form as claimed in claim 7, wherein the width is between 10 and 25 mm.

44. The material in sheet form as claimed in claim 1, wherein said first ply and/or said second ply comprises a security element.

45. The material in sheet form as claimed in claim 44, wherein said security element is a watermark or a security thread.

46. The material in sheet form as claimed in claim 44, wherein said security element is a wide thread, more than 2 mm wide, included in one of the plies and covered by the material of the other ply.

47. The material in sheet form as claimed in claim 1, wherein said recess of the second ply has a geometric shape, or is in the form of an alphanumeric character, of a symbol or of a design.

48. A security sheet, wherein it comprises a material in sheet form as claimed in claim 1, and at least one at least partially transparent element in said at least one elongate zone of zero thickness of the first ply.

49. The security sheet as claimed in claim 48, wherein said partially transparent element is attached to the security sheet by a hot melt adhesive.

50. The security sheet as claimed in claim 48, wherein said at least partially transparent element comprises at least one security means.

51. The security sheet as claimed in claim 50, wherein said security means is chosen from a variable optical effect device, an interferential, iridescent and/or diffractive device, a liquid crystal device, a system of lenses, a hologram, a magnetic, metallic or crystalline coating, magnetic fibers, tracers that can be detected by magnetic resonance, tracers that can be detected by x-ray fluorescence, biomarkers, a lacquer or ink, fluorescent tracers, or photochromic, thermochromic, electroluminescent and/or piezochromic and/or tribometric compounds and/or compounds which change color upon contact with one or more predetermined products.

52. The security sheet as claimed in claim 50, wherein said security means is a chip.

53. The security sheet as claimed in claim 50, wherein said security means is positioned exactly facing the at least one recess of the second ply.

54. The security sheet as claimed in claim 53, wherein said at least partially transparent element comprising said security means has a thickness close to that of the material in sheet form.

55. The security sheet as claimed in claim 48, wherein said at least partially transparent element has a thickness greater than 10 μm.

56. The security sheet as claimed in claim 55, wherein the thickness is between 10 and 50 μm.

57. The security sheet as claimed in claim 48, wherein said at least partially transparent element has the same thickness as said first ply.

58. The security sheet as claimed in claim 48, wherein said at least partially transparent element has a width equal to the width of the elongate zone of zero thickness of the first ply.

59. The security sheet as claimed in claim 48, wherein said at least partially transparent element is a continuous strip.

60. The security sheet as claimed in claim 48, wherein said at least partially transparent element is a patch.

61. The security sheet as claimed in claim 48, wherein said partially transparent element has a plastic backing.

62. The security sheet as claimed in claim 61, wherein the plastic is polyester.

63. The security sheet as claimed in claim 48, wherein said second ply of the material in sheet form comprises at least one watermark with a multi-tonal effect facing an at least partially transparent element of an elongate zone of zero thickness of the first ply of said material in sheet form.

64. A security document, wherein it comprises a material in sheet form comprising at least two fibrous plies juxtaposed on one another, a first ply comprising at least one elongate zone of zero thickness and a second ply comprising at least one recess, and said at least one recess of the second ply being situated facing said at least one elongate zone of zero thickness of the first ply, thus forming a window or a security sheet as claimed in claim 48.

65. The security document as claimed in claim 64, wherein said first ply comprises at least two security elements facing at least two recesses of the second ply, said two security elements being positioned in such a way that they become superposed when the security document is folded in order to form an additional security feature or additional information.

66. A method of manufacturing a material in sheet form involving the following steps:
creating a first ply of paper comprising at least one elongate zone of zero thickness by filtering an aqueous suspension of cellulose fibers on the wire cloth of a first cylinder mold or of a former,
creating a second ply of paper on the wire cloth of a second cylinder mold in such a way as to form at least one recess in said second ply,
assembling the two plies in such a way that at least one recess of the second ply faces said at least one elongate zone of zero thickness of the first ply, thus forming a window,
drying the structure thus obtained.

67. The method of manufacture as claimed in claim 66, wherein said elongate zone of zero thickness of the first ply is created by omitting to filter the suspension over at least one zone of the wire cloth of said first cylinder mold or of said former.

68. The method of manufacturing a material in sheet form as claimed in claim 67, wherein the omission of filtration on the first cylinder mold or on the former is achieved by depositing masking zones on the perimeter of said first cylinder mold or of said former.

69. The method of manufacturing a material in sheet form as claimed in claim 68, wherein said mask is made of an adhesive film, made of metal, made of an adhesive or made of a lacquer.

70. The method of manufacture as claimed in claim 66, wherein said elongate zone of zero thickness of the first ply is created by the removal of material by spraying a jet of pressurized fluid, before this ply is assembled with the second ply.

71. The method of manufacture as claimed in claim 70, wherein said jet of pressurized fluid is a jet of water.

72. The method of manufacture as claimed in claim 70, wherein said jet of pressurized fluid is a jet of air.

73. The method of manufacturing a material in sheet form as claimed in claim 1, wherein said wire cloth of the first mold or of the former additionally comprises components that prevent the filtration of the suspension so as to form complete absences of material in the fibrous material of said first ply.

74. The method of manufacturing a material in sheet form as claimed in claim 66, wherein said wire cloth of the first mold or of the former additionally comprises embossings so as to form partial absences of material in the fibrous material of said first ply.

75. The method of manufacturing a material in sheet form as claimed in claim 66, wherein said at least one recess on the second ply is created by embossing the wire cloth of the second cylinder mold.

76. The method of manufacturing a material in sheet form as claimed in claim 66, wherein said at least one recess on the second ply is obtained by attaching to the wire cloth of the second cylinder mold components that prevent filtration.

77. The method of manufacturing a material in sheet form as claimed in claim 76, wherein said component that prevents filtration is a piece of metal, a piece of adhesive, or a piece of resin.

78. The method of manufacturing a material in sheet form as claimed in claim 77, wherein the piece of metal is an electrotype.

79. The method of manufacturing a material in sheet form as claimed in claim 66, wherein said at least one recess on the second ply is obtained by the removal of material by spraying a jet of pressurized fluid, onto the second ply while it is still wet, before it is assembled with the first ply.

80. The method of manufacturing a material in sheet form as claimed in claim 79, wherein the jet of pressurized fluid is a jet of water.

81. The method of manufacturing a material in sheet form as claimed in claim 66, wherein the first cylinder mold or the former, and the second cylinder mold are synchronized so that the at least one recess of the second ply faces the at least one elongate zone of zero thickness of the first ply.

82. A method of manufacturing a security sheet involving the manufacture of a material in sheet form as claimed in claim 66, wherein it involves an additional step which consists in attaching an at least partially transparent element into the elongate zone of zero thickness of said first ply.

83. The method of manufacturing a security sheet as claimed in claim 82, wherein said at least partially transparent element is attached to the first and/or to the second ply of said sheet using a hot melt adhesive.
